(19) United States
(12) Patent Application Publication
(10) Pub. No.: US 2003/0028895 A1
(43) Pub. Date: Feb. 6, 2003

(54) System and method for managing disparate video network devices through objects

(75) Inventors: Mark S. Buehler, Cedar Park, TX (US); Kurtis L. Seebaldt, Round Rock, TX (US); Victor M. Santiago, Round Rock, TX (US)

Correspondence Address: Robert W. Holland, Baker Botts L.L.P., Suite 600, 2001 Ross Avenue, Dallas, TX, 75201-2980, US

(73) Assignee: VTEL Corporation, Austin, TX

(21) Appl. No.: 10/039,932

(22) Filed: Nov. 1, 2001

Related U.S. Application Data
(60) Provisional application No. 60/309,136, filed on Jul. 31, 2001.

(51) Int. Cl. H04N 7/173; H04N 7/16

(52) U.S. Cl. 725/119; 725/116; 725/147; 725/91

(57) ABSTRACT

A system and method for accessing and managing disparate video network devices supports a user interface with an interface protocol communicating through a management adapter. The management adapter communicates with a device access layer that represents video network devices as objects, such as Management Beans, with a class of objects associated with a type of device. The objects translate communications from the management adapter into a protocol and attributes native to the device to allow the management adapter access to device attributes, which are then available to the user interface via the interface protocol. The device access layer thus establishes a proxy relationship so that video network devices are more easily interacted with and managed by applications communicating through the management adapter by a uniform protocol. The object attributes provide variables for the dynamic creation of a management information base associated with a device that aids a management application's management of disparate devices.

### RELATED APPLICATIONS

This application claims priority to U.S. Provisional Application Serial No. 60/309,136, filed on Jul. 31, 2001, and entitled “System and Method for Managing Disparate Video Network Devices Through a Management Information Base.”

### TECHNICAL FIELD

This invention relates generally to video network communications, and more specifically relates to a system and method for managing video network devices.

### BACKGROUND OF THE INVENTION

Video conference calls have grown in popularity as the expense of video conferencing devices has decreased and the availability of broadband communication networks has increased. Businesses often prefer the more personal communication available through video conferences compared with telephone conferences, and also enjoy savings in travel costs while still having a personal presence among the participants that is not possible with audio only communications. The increased popularity of video conferencing has resulted in the deployment of video network devices in wide ranging disparate locations with the devices interfaced by business networks or the public network. Often, video calls involve the interfacing of video network devices manufactured by a variety of different manufacturers and using a variety of protocols and network communication interfaces.

As video network devices grow in number, the task of managing the devices, including scheduling, monitoring and diagnosing problems of the devices, grows in complexity. For instance, a single video network might interface with video end points, multi-call units known as multipoint control units (MCUs), and gateways each manufactured by different manufacturers and using different communication protocols and interfaces. Each of these devices may include specific management, maintenance and monitoring needs that makes central management of a network difficult to accomplish.

One difficulty with management of video devices is establishing a uniform representation of the devices for use by management applications. Different vendors of video conferencing devices typically use their own proprietary mechanisms for device management. A typical business video network includes devices from several vendors so that such video networks use multiple means to manage the devices. In addition to having widely different management user interfaces, many of these disparate video devices are accessible only through specific protocols, including SNMP, HTTP, telnet, RS-232, etc . . . Although MIB H.341, a multimedia Management Information Base (MIB), was accepted by a standards committee, few vendors implement this standard and many vendors lack the SNMP interface used by the standard.

Although the use of MIBs, such as MIBs available with Internet Protocol (IP) accessible devices having remote SNMP management, simplify device management, a certain degree of expertise is typically needed to access and use MIBs. A MIB for a particular device may be large with an extensive list of available attributes, attribute types and access properties so that an administrator typically must have a degree of familiarity with the MIB to locate specific information of interest, such as with a MIB browser. Further, the administrator may have to track multiple MIBs for a given device or devices with desired information distributed throughout the MIBs, making it difficult and inconvenient for the administrator to obtain a specific set of information in one place at one time. Of course, since disparate devices do not have uniform MIBs or, in some instance, are not supported by MIBs at all.

Without a uniform means of communicating with different types of devices, management applications have difficulty accessing disparate devices on a realtime basis and generally must be updated as devices on the video network are changed or reconfigured. Thus, video network operational staff is typically faced with a complex task of maintaining video networks by tracking changes to the network and updating management applications and devices on an individual basis. This increases the cost and complexity of video networks and also results in reduced reliability.

### SUMMARY OF THE INVENTION

Therefore a need has arisen for a system and method which provide realtime management of disparate video network devices through a centralized video network platform.

A further need has arisen for a system and method which provides flexibility in adding or updating disparate video devices on a video network to reduce the complexity of managing the different types of video network devices.

A further need has arisen for a system and method which organizes network device attributes so that MIB variables or interest to a user are more easily accessible.

A further need has arisen for a system and method which provides SNMP management through a MIB for non-SNMP network devices.

In accordance with the present invention, a system and method are provided which substantially reduce the problems and disadvantages of managing network devices. Network devices are represented as objects having attributes that handle protocol conversion between a device native protocol and a management interface protocol and that translate management instructions into device-specific attribute instructions. The object attributes for a device are included in a dynamically created MIB for use by a management application so that the management application manages disparate devices having disparate native protocols by using a common management interface protocol.

More specifically, a video network platform includes a management adapter accessible to a user interface and a device access layer interfaced with the management adapter and the video network. The management adapter has a MIB that identifies video network devices associated with the video network. The device access layer represents the video network devices as objects operable to translate information from a format associated with the management adapter interface into a format associated with a video network device.

The management adapter is accessible to users and management applications through one or more user interfaces having an interface protocol. For instance, a commercially available network management system such as HP Openview provides a user interface to the management adapter using an interface protocol, such as SNMP, interfaced with an interface protocol adapter associated with the management adapter. The protocol adapter identifies video network devices by reference to a MIB, such as an H.341 compliant MIB. Alternatively, the protocol adapter looks up video network devices in target look up table.

Requests for communication with one or more video network devices are forwarded to a device access layer which associates the requested video network device with an object that represents the video network device. For instance, the management adapter requests access to a video network device using a device access layer protocol, such as RMI, that accesses a Management Bean object representing the video network device on the device access layer. The device access layer divides Management Beans into classes, with each class associated with a type of video network device, such as endpoint devices, gatekeeper devices, gateway devices, MCU device and network devices, such as routers. The Management Bean translates requests for access to the device from the format of the management adapter into the format used by the device to allow communication with and management of the video network device in its native format.

A MIB summation engine dynamically creates a MIB for a network device by selecting attributes of the management beans for the device along with variables from other MIBs so that the dynamically-created MIB has a user-specific structure in an order and organization of the user's choice. The dynamically-created MIB is usable in a network management application to manage the associated device so that the device will appear to expose only those variables of interest to the user associated with the MIB organized in a structure that makes sense without change to the device itself. For instance, a dynamically created MIB for a non-SNMP device aids an SNMP management application in the management of the device through an object, such as a management bean.

The present invention provides a number of important technical advantages. One important technical advantage is that disparate video network devices with different native formats are accessible from a video network platform that uses a defined format more easily accessible by a user interface. For instance, the management adapter establishes a common defined interface for a type of video network device, such as endpoint devices, thus allowing a user interface to communicate with a type of devices through the same interface. The management adapter accesses the video network devices through Management Beans with each device represented by a Management Bean that translates communications from the management adapter into the native format of the video network device. Types of devices are represented by classes of Management Beans to establish consistent interfaces.

Another important technical advantage of the present invention is that disparate video network devices are interfaced with a video network in a more simple manner. By representing types of devices as classes of Management Beans, the device access layer allows access by the management adapter of attributes of devices for user access and management of the devices. The device access layer applies Management Beans to translate communications between the management adapter format and the native format of the video network device so that new devices or changes to existing devices are more easily made accessible for management by modifying the device access layer Management Beans instead of the management applications or user interface.

Another important technical advantage is that dynamically created MIBs organize network device attributes so that MIB variables of interest to a user are more easily accessible. The MIB summation engine allows selection of variables for a MIB so that only variables of interest to a user associated with the dynamically-created MIB are exposed in an organization of the user's selection. This reduces the complexity of interacting with a large variety and number of different MIBs and MIB variables which may have varied natures depending upon the associated underlying device.

Another important technical advantage is that the dynamically-created MIB provides SNMP management for non-SNMP network devices. Network devices that do not offer SNMP management or that offer only partial SNMP management are accessible through object representations that expose variables of interest.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a block diagram of video network platform providing access to video network devices through a management adapter and device access layer;

FIG. 2 depicts a block diagram of a video network platform with standardized attributes for accessing video network devices;

FIGS. 3A and 3B depict block diagrams of a user interface for communicating with disparate video devices using MBeans; and

FIG. 4 depicts a block diagram for dynamic MIB creation for a video device.

### DETAILED DESCRIPTION OF THE INVENTION

Preferred embodiments of the present invention are illustrated in the FIGURES, like numerals being used to refer to like and corresponding parts of the various drawings.

Video networks typically deploy disparate video network devices manufactured by different vendors to communicate with different formats. For instance, a typical video network might deploy video endpoints manufactured by different vendors with one endpoint managed by a management application communicating via an SNMP format and another endpoint communicating with a management application via HTTP format. Larger networks are likely to include different types of video network devices, such as MCUs, gateways, gatekeepers and network devices, each of which is designed to communicate by different formats for management by vendor-specific applications.

A video network that deploys disparate video network devices often presents a challenge for staff to manage and maintain. For instance, several management applications may be needed to manage devices of a single type deployed in a video network, with each vendor having its own management application. As devices are added to the video network or changed on the video network, management applications may also change, increasing the complexity of maintaining the video network. If a business attempts to use only a single vendor, the business may face increased cost for devices and reduced selection and functionality. Thus, common management of video network devices by a central platform offers substantial improvements in terms of simplicity and cost as well as reliability.

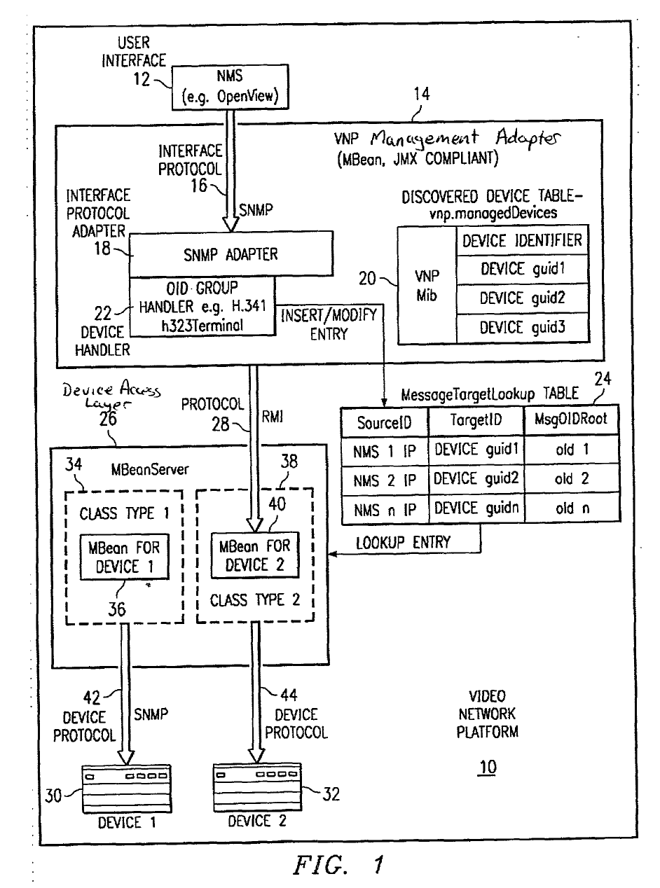

Referring now to FIG. 1, the present invention provides a video network platform 10 that simplifies video network device management by offering access through a single common interface. A user interface 12, such as the HP Openview network management system, provides a uniform protocol, such as SNMP, which allows users and management applications to access video network devices in a consistent manner. Thus, a business may interface common video network management applications to manage disparate video devices, even devices that have native formats that are different from that of the management application.

User interface 12 interfaces with a management adapter 14 through an interface protocol 16 and an interface protocol adapter 18. Interface protocol adapter 18 allows the network operator to select different types of interface protocols 16 so that a variety of management applications using a variety of interface protocols may be used to manage video network devices. Interface protocol adapter 18 determines the video network device requested by user interface 12 and accesses that device through a query to a MIB 20. For instance, MIB 20 is an H.341 compliant MIB that provides standardized management of video network devices. If the request from user interface 12 can be satisfied by reference to MIB 20 or message target lookup table 24 accessed by device handler 22, such as when the attributes are part of the MIB that the management adapter implements, then management adapter 14 generates a response accordingly.

If the request from user interface 12 includes a message to a particular instance of a video network device, such as from the list of devices available from a MIB attribute, the device is accessed by setting an attribute in the MIB to a globally unique identifier for the device. For instance, interface protocol adapter 18 sends a message from user interface 12 to management adapter 14's MIB 20, vnp.managedDevices, that sets the vnp.managedDevices.targetDeviceGUID attribute to the globally unique identifier (guid) received for that device, such as managedDeviceTable.managedDeviceEntry. deviceGUID. Management adapter 14 then accesses device access layer 26 through a device access layer protocol 28, such as RMI.

Device access layer 26 stores object representations of devices that provide a uniform interface with management adapter 14 for types of devices. For instance, one object class exists for each of endpoint type, MCU type, gateway type, gatekeeper type and network device type of devices interfaced with the video network. The interface for each member of a class of objects is the same even though video network devices represented by objects of the class are of disparate types having different types of native formats. For instance, if device 30 is an endpoint device that communicates with SNMP protocol and device 32 is an endpoint device that communicates by Telnet protocol, both devices 30 and 32 are represented by objects of the same class having the same interface with management adapter 14. However, the object associated with device 30 translates communications from management adapter 14 into the native protocol of device 30 and the object associated with device 32 translates communications from the management adapter 14 into the native protocol of device 32. This architecture advantageously allows management adapter 14 to access device mechanisms for remote management in accordance with the H.341 standard even if a particular device does not support the standard. As devices are interfaced with the video network, objects are created to represent the devices without altering management adapter 14 or management applications that use management adapter 14 to manage video network devices.

In the embodiment depicted by FIG. 1, device access layer 26 is a Management Bean server that encapsulates device access into Management Beans according the to the Java Management Extensions (JMX) framework. A first class of Management Beans 34 represents video network devices of a first type with Management Beans 36. A second class of Management Beans 38 represents video network devices of a second type with Management Beans 40. For instance, endpoint devices are represented by the first class and MCU devices are represented by the second class. Each Management Bean supports a device protocol that supports an interface with its associated device. For instance, a Management Bean 36 that represents an endpoint device 30 may communicate with the SNMP protocol while another Management Bean 38 that represents an endpoint device 30 from a different vendor may communicate with HTTP or with the Telnet protocol.

The use of Management Beans to translate communications from external management applications for use by disparate video devices enables realtime access through a standardized naming scheme, effectively hiding the complexity of a video network and reducing the need for vendor specific management applications. Management adapter 14 allows users and management applications to read information based on the class of a device instead of specific vendor models and their associated protocols. Thus, for instance, an external SNMP manager for a type of device accesses device management information from a MIB and device specific information directly from devices even though the devices do not support an SNMP interface. In this way, video network complexity is reduced and user flexibility is increased.

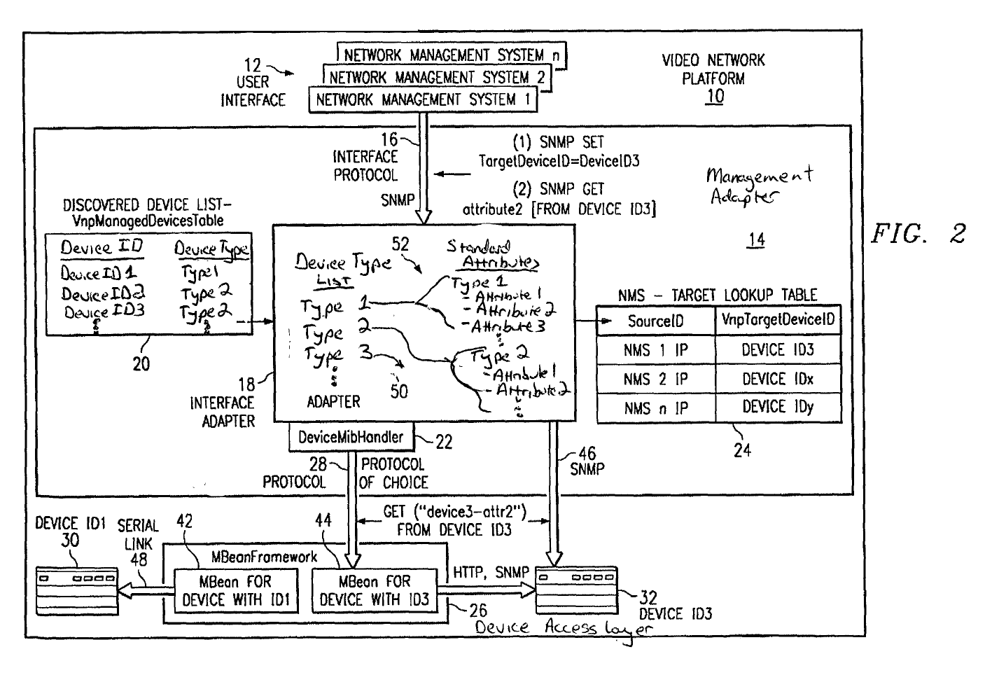

Referring now to FIG. 2, an alternative embodiment of the present invention is depicted which supports plural SNMP managers to access management information as well as device specific information from video network platform 10. Standard attributes that are common across different types of video network devices are translated into device specific attributes.

User interfaces 12 provide access to video network platform 10 by plural network management systems. The network management system user interfaces 12 communicate with management adapter 14 through an interface protocol 16, such as SNMP, and interface adapter 18. Generally, the types of requests for information from the network management systems fall within three categories: 1.) requests for information associated directly with video network platform 10; 2.) requests for information associated with a video network device and available through an object representation of the device, such as an MBean representation; and 3.) requests for information associated with a video network device that is not represented by an object, such as a video network device having a proprietary MIB.

Requests for information represented as attributes are satisfied through interface adapter 18 in cooperation with device access layer 26 and provided to the network management system user interface 12 accordingly. Requests for information from devices are communicated through interface adapter 18 to either device handler 22 for devices represented by an MBean or through a device interface 46, such as a device-specific protocol like SNMP, for devices not represented by an MBean. A discovered device list 20 and target lookup table 24, such as may be made available through a MIB, aid in the identification of attributes for types of devices for the network.

For requests for a particular instance of a device, the network management system user interface 12 sets the managedDevices.vnpTargetDeviceID attribute from the VNPManagedDevices table 20 to a device identifier associated with the device. Management adapter 14 inserts an entry into target lookup table 24 to set a value of an indentifier, such as an IP address, for the network management system user interface 12 correlated to the device identifier. Interface adapter 18 routes messages to an MBean through device handler 22 and a desired device access layer protocol 28, or routes messages directly to the device using SNMP interface 46. Messages from the network management system 12 are forwarded to the device under management until network management user interface 12 sends a message to change the vnpTargetDeviceID attribute.

Interface protocol adapter 18 and device access layer 26 support both protocol conversion and attribute translation. For instance, a network management system user interface 12 uses SNMP to establish communications with a device 30 having a serial link 48 through an MBean 42. Similarly, an MBean 44 supports either an HTTP or SNMP interface with a device 32, which also has a direct SNMP interface 46 through interface adapter 18. Interface adapter 18 accesses standardized attributes 52 that translate to MBean supported attributes that are device specific based on device type. There is, for instance, a set of standardized attributes for each different device type. Interface adapter 18 communicates with device access layer 26 to perform attribute translation by determining whether the device supports the requested attribute and, if so, translating to the device specific attribute.

As an example, a network management system user interface 12 sets a TargetDeviceID to DeviceID3 and obtains attributes for device 32 through standardized attributes 52 having MBean supported attributes based on the type of device 50, such as a video endpoint, MCU, gateway, TCP/IP router or other network device. Protocol conversion and attribute translation performed by management adapter 14 via communication with standardized attributes through device access layer 26 are isolated from network management and other applications, thus simplifying the establishment of an interface between video network devices and video network management applications. Once an IP address is established for user interface 12 to communicate with a device, the user interface continues to use that IP address until communication with the device is complete, thus limiting the number of table look-ups required.

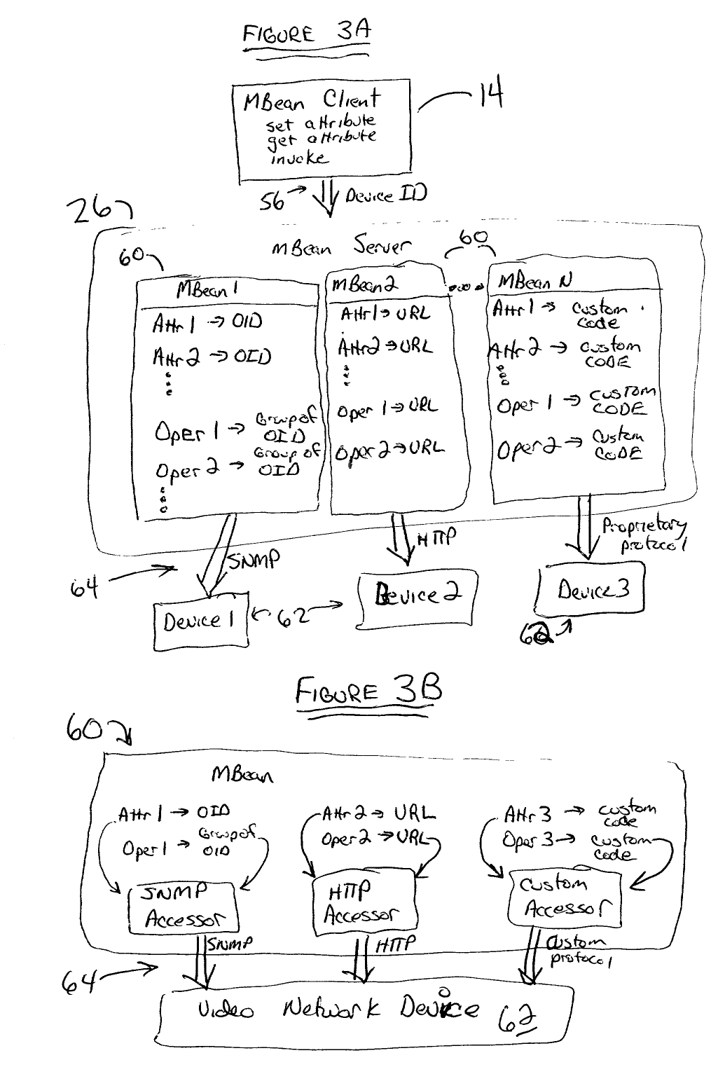

Referring now to FIGS. 3A and 3B, block diagrams depict the flow of information between a management adapter 14 and plural video devices 62 accomplished through MBean object representations 60 of the video devices 62. A user seeking information from or seeking to interact with a video device 62 selects the desired video device through management adapter 14, such as by selecting an icon representing the video device depicted by a graphical user interface associated with management adapter 14. For instance, clicking on the icon that represents a video network device associated with MBean1 60 results in an SNMP request to call a getAttribute, setAttribute or invoke for the video network device 62 associated with MBean1 60. The management adapter 14 acts as an MBean client that communicates over a device access layer protocol 56 with a device access layer MBean server 26.

Device access layer 26 includes MBeans 60 that represent the video devices 62 interfaced with the video network 64. The getAttribute, setAttribute and invoke requests from management adapter 14 are handled as a MBean client request to MBeans of device access layer 26 using device access layer protocol 28. MBeans 60 include attributes and operations to get, set or invoke the requested information from the selected video device 62 using the native protocol understood by the selected device, such as HTTP, SNMP, serial or custom protocols. For instance, MBean1 60 supports OID attributes and operations for SNMP, MBean2 60 supports URL attributes and operations for HTTP, and MBeanN supports custom coded attributes and operations.

Referring to FIG. 3B, a block diagram depicts that a MBean for a video network device supports one or more than one native protocol interface with a video network device 62. MBean 60 includes attributes and operations to invoke an SNMP, HTTP or custom accessor that in turn communicates over the native protocol of network device 62. Thus, the MBean 60 is adaptable as needed to establish communication over a variety of native protocols by having attributes and operations to call an appropriate accessor module for the native protocol. MBean 60 determines if get, set and invoke requests from management adapter 14 are supported by the associated video network device 62 and, if supported, perform attribute translation to provide the appropriate information to video network device 62.

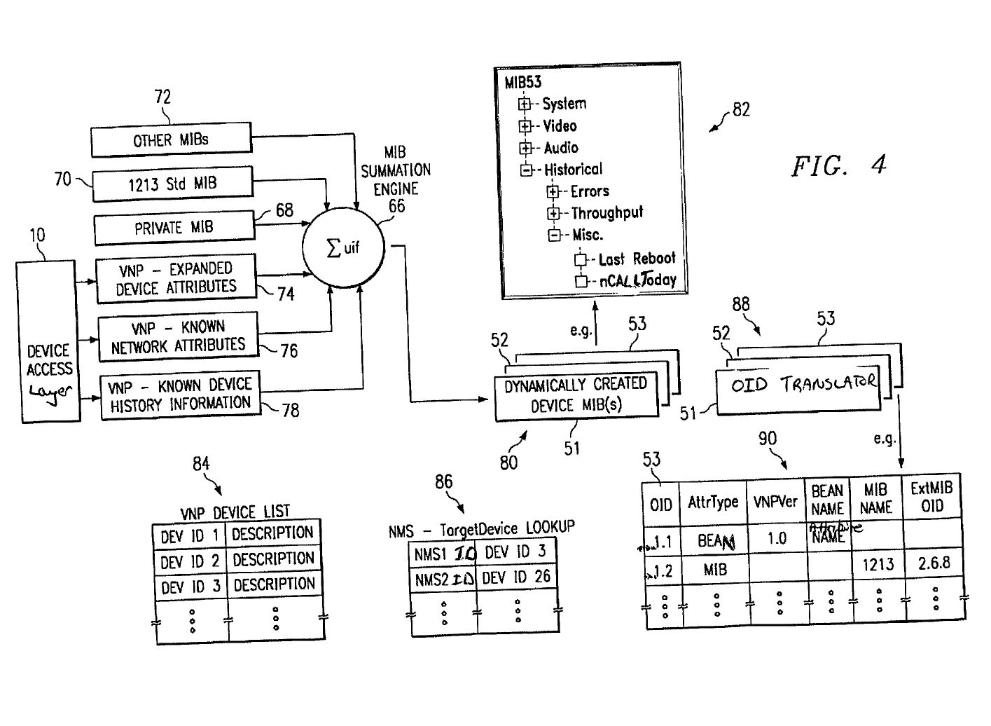

Referring now to FIG. 4, a block diagram depicts the dynamic creation of MIBs that simplify support for applications interfacing with video devices through video network platform 10. IP-accessible video devices that provide remote SNMP management typically offer conventional MIBs to manage information associated with the video device. Such conventional MIBs are sometimes large and include many available attributes, attribute types and access properties, such as read and write access, for the video device. However, for complex networks with many video devices, conventional MIBs are unwieldy and difficult to work with. For instance, an administrator monitoring a number of remote devices, especially of disparate type, typically must access information with a MIB browser by knowing where, within each MIB, the information exists. With many disparate devices, information is distributed throughout a number of MIBs so that it is often inconvenient and indeed impossible to see a specific set of information in one place at one time. This difficulty is increased where a video network includes devices that do not offer SNMP management or MIBs, or only offer partial management and incomplete MIBS.

To improve access to information for a video device, a MIB summation engine 66 dynamically creates a MIB for a selected device by including the variables of interest to a defined user in an order and organization determined by the defined user. Variables for the dynamically created MIB are selected from existing MIBs and other sources so that the user-specific, dynamically-created MIB localizes variables of interest without complicating the use of those variables through the presence of unnecessary variables.

For instance, IP-accessible devices that have SNMP management typically include a private MIB 68 with a detailed list of variables specific to the device. When deployed to a video network, the video device may also have a standard MIB 70 that complies with the 1213 standard and other MIBs 72. MIB summation engine 66 accesses private MIB 68, standard MIB 70 and other MIBs 72 to dynamically create user-specific MIB 80 having selected variables organized in an order defined for the user.

In addition to those variables tracked by existing MIBs, other attributes are sometimes of interest to a user that are not available through an existing MIB. For instance, some video devices offer only partial MIBs with partial SNMP management or completely fail to offer SNMP management and MIBs all together. Thus, attributes of such video devices are not available to non-proprietary network management programs, such as HP Openview, unless the attributes are exposed for access, such as through SNMP. However, video network platform 10 provides exposure to variables of interest through representation of video devices as objects, such as MBeans. MIB summation engine 66 coordinates the inclusion of attributes exposed by MBeans through video network platform 10 into dynamically created MIBs 80. For instance, MIB summation engine 66 accesses lists such as expanded device attributes 74 which are non-SNMP based MBean attributes, known network attributes 76 and known device history 78 exposed through MBeans of video network platform 10 to allow inclusion of selected attributes from these list in a dynamically-created MIB 80. This advantageously allows a dynamically created MIB to include variables and attributes of interest for management of a video device without requiring any change to the underlying device itself.

MIB summation engine 66 provides a user interface to allow an administrator to select from attributes available from MIBs and objects associated with a video device, such as MIBs 68, 70 and 72 and from lists 74, 76 and 78. Once MIB summation engine 66 dynamically creates a MIB 80 with attributes and structure specific to a user, the dynamically-created MIB 80 can be taken to a network mode manager of the user's choice, such as HP Openview operating as a user interface to video network platform 10, to manage the video device associated with the dynamically-created MIB 80, such as described above through MBeans. This advantageously allows the user to view the device with the exact variables of interest to that user exposed through dynamically-created MIB 80 organized in a structure that makes the best sense for that user.

MIB summation engine 66 allows multiple MIBs to be created with different objectives in mind such as having a MIB with specific structure and content available to a pre-defined or restricted set of users, another MIB with super-users and yet another MIB that contains read-only variables. In the embodiment depicted by FIG. 4, the user interface for MIB summation engine 66 creates an organized tiered-folder MIB structure and places selected attributes within that structure. MIB summation engine 66 has dynamically-created three user-specific MIBs 80 with attributes selected from MIBs 68, 70 and 72 and from attribute lists 74, 76 and 78. MIB file 82 illustrates an example of attributes for dynamically-created MIB 80 with the file identifier of MIB53. A dynamic MIB OID translator table 88 is created with each MIB to translate the attributes from the dynamically-created MIB 80 to their source location.

Once stored on a network management system, such as a management application running on video network platform 10, MIB53 is available for access with a MIB browser or an external manager, such as an external SNMP node manager like HP Openview, which uses the device and user-specific MIB to point video network platform 10 to the associated video device. For instance, the video device is selected from a device list 84 that lists video devices associated with video network platform 10 and a target device look-up table 86 that associates individual network management system clients with the specific device they are accessing, such as network application identification with devices identification. Video network platform 10 uses dynamic MIB OID translator 88 to get information from devices with OIDs presented in dynamically-created MIB 82. For instance, translator table 90 for MIB53 references OID 1.1 to an MBean from expanded device attributes list 74 and OID 1.2 to a MIB attribute from standard MIB 70. With dynamic MIB 82 limited to variables of interest to the user of that MIB, relevant information is presented in a manner that allows the user to track the information in an organized manner over time.

Although the present invention has been described in detail, it should be understood that various changes, substitutions and alterations can be made hereto without departing from the spirit and scope of the invention as defined by the appending claims.

What is claimed is:

1. A system for managing video network devices, the system comprising:
a management adapter accessible to a user interface, the management adapter having a list that identifies the video network devices; and
a device access layer interfaced with the management adapter and the video network devices, the device access layer representing the video network devices as objects to support management of the video network devices through the management adapter.

2. The system of claim 1 wherein the device access layer represents the video network devices as Management Beans.

3. The system of claim 2 wherein each video network device communicates with the network through one of plural protocols, the Management Bean for a video network device communicating with the video network device in the protocol associated with the video network device.

4. The system of claim 3 wherein the Management Beans communicate with the management adapter using a common protocol.

5. The system of claim 1 wherein the video network devices have plural types, the device access layer representing each type of video network device as an object class.

6. The system of claim 5 wherein a video network device belongs to plural types, the device access layer representing the video network device as plural objects, each of the plural objects belonging to a class corresponding to the plural types.

7. The system of claim 5 wherein a video network device type comprises an endpoint type.

8. The system of claim 5 wherein a video network device type comprises an MCU type.

9. The system of claim 5 wherein a video network device type comprises a gatekeeper type.

10. The system of claim 5 wherein a video network device comprises a gateway type.

11. The system of claim 5 wherein a video network device comprises a network device type.

12. The system of claim 1 wherein the device access layer comprises a Management Bean server having Management Bean objects that correspond to the video network devices, each Management Bean object encapsulating attributes that support access to a video network device.

13. The system of claim 1 wherein the video network devices comprise one or more of plural device types, each device type having a common interface defined by a Management Bean class.

14. The system of claim 13 further comprising first and second video network devices interfaced with the device access layer, the first and second video network devices having a common device type represented by a common Management Bean class, the first video network device communicating with a first Management Bean by a first format, the second video device communicating with a second Management Bean by a second format, the first and second Management Beans communicating with the management adapter by a common format.

15. A method for communicating with first and second video network devices having first and second communication formats, the method comprising:
interfacing with a management platform through a management interface format to identify the video network devices;
associating the first video network device with a first object and the second video network device with a second object;
translating communication to the first video network device with the first object from the interface format to the first communication format; and
translating communication to the second video network device with the second object from the interface format to the second communication format.

16. The method of claim 15 wherein the first and second objects comprise Management Beans.

17. The method of claim 15 wherein the management interface format comprises SNMP.

18. The method of claim 15 further comprising:
dividing the video network devices into types of devices; and
establishing an object class for each type of video network device.

19. The method of claim 18 wherein each type of video network device has a common interface for exchanging data between an external interface and objects of the class associated with the type of video network device.

20. A method for interfacing an SNMP management application with network devices having disparate native interface protocols, the method comprising:
representing each device as a Management Bean stored on a server;
providing an SNMP management instruction for a device to an SNMP adapter;
communicating the SNMP management instruction using the SNMP adapter as a management bean client in communication with the server; and
communicating the SNMP management instruction from the server through the management bean representing the device to the device in the native protocol of the device.

21. The method of claim 20 further comprising:
associating the device receiving the SNMP management instruction with an IP address; and
communicating a second SNMP management instruction to the device with the IP address.

22. The method of claim 20 further comprising:
listing the network devices in a MIB; and
associating the network devices with IP addresses with the SNMP adapter.

23. The method of claim 20 further comprising:
communicating between the management bean client and the server with standardized attributes defined for each device.

24. The method of claim 20 wherein the network devices comprise video devices.

25. A system for interfacing plural network devices with an application through an SNMP interface, the network devices having disparate native protocols, the system comprising:
an adapter in communication with the application to accept SNMP instructions from the application for a network device;
an agent in communication with the adapter, the agent representing the network devices as objects having attributes;
wherein the adapter and agent cooperate to convert the SNMP instructions to the native protocol with the network device object attributes translated into requests to the network device in the native protocol of the network device.

26. The system of claim 25 wherein the network devices comprise video network devices.

27. A method for managing a video network having plural video devices, the method comprising:
representing each video device as an object having attributes;
communicating management instructions to the objects of the video devices; and
translating object attributes of the communication instructions into device-specific instructions to manage one or more of the video devices.

28. The method of claim 27 further comprising:
listing the attributes of an object that represents a video device; and
selecting one or more attributes to create a MIB for the video device.

29. The method of claim 28 further comprising:
selecting one or more variables from one or more pre-existing MIBs associated with the video device for inclusion with the created MIB.

30. The method of claim 28 wherein the created MIB cooperates with a management application for communicating management instructions to the object associated with the video device.

31. The method of claim 30 wherein the communication instructions comprises SNMP management instructions.

32. The method of claim 31 wherein the object comprises a management bean.

33. The method of claim 28 wherein the created MIB consists of read-only variables.

34. The method of claim 28 wherein the created MIB comprises variables for a restricted set of users.

35. The method of claim 27 wherein the device specific instructions comprise non-SNMP instructions.

36. A system for managing a video network having plural video network devices, the system comprising:
plural objects, each object having attributes to represent a video network device;
one or more lists of the attributes;
one or more MIB having variables of the video network device; and
a MIB summation engine operational to select one or more attributes and one or more variables to dynamically create a MIB for a predetermined one of the video network devices.

37. The system of claim 36 wherein the created MIB comprises a structure associated with a predetermined and restricted set of users.

38. The system of claim 37 wherein the structure comprises a tiered folder structure.

39. The system of claim 36 wherein the created MIB comprises read only variables.

40. The system of claim 36 further comprising a management application associated with the video network and operational to manage the video devices.

41. The system of claim 40 wherein the management application comprises an SNMP application.

42. The system of claim 41 wherein the created MIB cooperates with the management application to manage the video network device.

43. The system of claim 42 wherein the object translates instructions from the management application to a protocol native to the network video device.

44. The system of claim 43 wherein the object comprises a management bean.

45. A method for managing disparate video network devices with an SNMP application, the disparate video network devices having disparate native protocols, the method comprising:
representing the video network devices as objects having attributes, the objects translating instructions from the SNMP application to a native protocol of the video network device associated with the object;
dynamically creating a MIB for a video network device from selected attributes of the object associated with the video network device; and
accessing the dynamically created MIB with the SNMP application to manage the associated video network device.

46. The method of claim 45 wherein dynamically creating further comprises:
dynamically creating the MIB from selected variables of pre-existing MIBs associated with the video network device.

47. The method of claim 45 further comprising:
creating a translator table to associate the attributes with the dynamically created MIB.

48. The method of claim 45 wherein the SNMP application comprises HP Openview.

49. The method of claim 45 wherein dynamically creating the MIB further comprises:
selecting attributes for inclusion in the MIB to customize the MIB for a specific user.
